(19) United States
(12) Patent Application Publication
(10) Pub. No.: US 2013/0202998 A1
(43) Pub. Date: Aug. 8, 2013

(54) METHOD FOR PRODUCING AQUEOUS DISPERSION OF RESIN FINE PARTICLES AND METHOD FOR PRODUCING TONER

(71) Applicant: CANON KABUSHIKI KAISHA, Tokyo (JP)

(72) Inventors: Ryuji Higashi, Kawasaki-shi (JP); Masao Suzuki, Kawasaki-shi (JP); Shohei Fukuya, Tokyo (JP); Takashi Hirasa, Yokohama-shi (JP)

(73) Assignee: CANON KABUSHIKI KAISHA, Tokyo (JP)

(21) Appl. No.: 13/724,980

(22) Filed: Dec. 21, 2012

(30) Foreign Application Priority Data
Feb. 6, 2012 (JP) 2012-022764

(51) Int. Cl. G03G 9/08; C08L 67/02

(52) U.S. Cl. CPC G03G 9/081; C08L 67/025
USPC 430/137.13; 524/238; 430/137.14

(57) ABSTRACT

The present invention provides a method for producing an aqueous dispersion of resin fine particles wherein the particle size of the obtained resin particles is small and the aqueous dispersion is excellent in productivity, the production method including: mixing a resin having an acid group, a betaine surfactant and a solvent capable of dissolving the resin having an acid group to obtain a mixture; and emulsifying the mixture by placing the mixture in an aqueous medium and by applying shear force to the mixture under a condition of pH=7.0 or more to obtain an emulsion.

### BACKGROUND OF THE INVENTION

1. Field of the Invention

The present invention relates to a method for producing an aqueous dispersion of resin fine particles used in the fields of printing materials such as toners and inks for electrophotography, coating materials, adhesives, tackifiers, fiber processing, paper manufacturing and paper processing, and civil engineering, and a method for producing toner.

2. Description of the Related Art

Resin fine particles are used in a wide variety of fields of, for example, coating materials (Japanese Patent Application Laid-Open Nos. H05-98193, H06-25567, 2002-53790 and 2007-254612), constituting materials of aggregated toners (Japanese Patent Application Laid-Open No. 2010-77319), electrostatic recording materials (Japanese Patent Application Laid-Open No. 2007-279328), liquid developers for electrostatic printing (Japanese Patent Application Laid-Open No. 2009-30000), inks for ink jet printers (Japanese Patent Application Laid-Open No. H08-231908) and inks for electronic paper (Japanese Patent Application Laid-Open No. 2004-287061). In any of these fields, the control of the particle sizes and the particle size distributions of resin fine particles is important. In particular, simultaneous pursuit of particle size reduction and sharpness of the particle size distribution is desired in production of resin fine particles. In particular, for the purpose of reducing the environmental load, aqueous dispersions of resin fine particles have been investigated with respect to coating materials (Japanese Patent Application Laid-Open Nos. 2002-53790 and 2007-254612), constituent materials of aggregated toners (Japanese Patent Application Laid-Open No. 2010-77319) and inks for ink jet printers (Japanese Patent Application Laid-Open No. H08-231908).

In particular, when an aqueous dispersion of resin fine particles is used as a constituent material of an aggregated toner, it is necessary to more precisely control the particle size of the resin fine particles. This is because the particle size and the particle size distribution of the resin fine particles affect the particle size distribution of the toner particles after aggregation, and consequently affect the image formed with the toner. As a method for producing such resin fine particles, there has been proposed a method referred to as the phase-transfer emulsification method which uses an organic solvent (Japanese Patent Application Laid-Open No. H08-211655). Resin fine particles are obtained comparatively easily by this method. On the other hand, from the viewpoints of the environmental load reduction and the natural resources saving, there has recently been proposed a solventless emulsification method which yields a resin dispersion almost without using an organic solvent (Japanese Patent Application Laid-Open Nos. 2004-189765 and 2007-106906).

### SUMMARY OF THE INVENTION

An aspect of the present invention is (1) a method for producing an aqueous dispersion of resin fine particles, including the steps of: (A-1) preparing a mixture A by mixing a resin having an acid group, a betaine surfactant and a solvent capable of dissolving the resin; and (A-2) preparing an emulsion A by adding the mixture A into an aqueous medium, and applying shear force to the mixture A in the aqueous medium under a condition of pH=7.0 or more.

Another aspect of the present invention is (2) a method for producing an aqueous dispersion of resin fine particles, including: (B-1) preparing a mixture B by mixing a resin having an acid group, a betaine surfactant and an aqueous medium; and (B-2) preparing an emulsion B by applying shear force to the resin in the mixture B under a condition of pH=7.0 or more and at a temperature equal to or higher than the glass transition temperature (Tg) of the resin.

Yet another aspect of the present invention is a method for producing a toner including toner particles each of which includes a binder resin and a colorant, wherein the toner particles are obtained by: aggregating the resin fine particles and the colorant in the aqueous medium, after the aqueous dispersion of resin fine particles produced by the method according to the foregoing (1) or (2) and colorant are mixed, to obtain an aqueous dispersion of aggregates; and fusing the aggregates by heating the aqueous dispersion of the aggregates.

Still yet another aspect of the present invention is a method for producing a toner including toner particles each of which includes a core particle containing a binder resin and a colorant and a shell phase formed on the surface of the core particle, wherein the toner particles are obtained by forming the shell phase by attaching the resin fine particles in the aqueous dispersion of resin fine particles produced by the method according to the foregoing (1) or (2) to the core particle.

The present invention enables an aqueous dispersion of resin fine particles small in particle size to be provided in the case of a resin having an acid group. In particular, an aqueous dispersion of resin fine particles is obtained with an emulsification method substantially using no organic solvent. This is important from the viewpoint of environmental load reduction. Moreover, the present invention enables stable provision of fine particles of a hydrolyzable resin such as polyester although the provision of such particles has been generally difficult. In the emulsification of a hydrolyzable resin, it is possible to reduce the amount of a base to promote the self-emulsification performance, and hence hydrolysis can be suppressed. The present invention enables the production of a toner which allows low-temperature fixability and heat resistant storage stability to be compatible with each other.

Further features of the present invention will become apparent from the following description of exemplary embodiments.

### DESCRIPTION OF THE EMBODIMENTS

When aqueous dispersions of resin fine particles were produced by using the production methods described in Japanese Patent Application Laid-Open Nos. H08-211655, 2004-189765 and 2007-106906, sometimes it was difficult to obtain resin fine particles having particle sizes required when used as raw materials for aggregated toners. A resin having an acid group has self-emulsifiability in water, and hence it has hitherto been thought that an aqueous dispersion of the resin fine particles of such a resin can be comparatively easily obtained. However, as has been found, in particular, in the case of a resin having an acid number of 1.0 to 10.0 mg KOH/g, the particle size reduction of the resin fine particles is limited even with the use of a surfactant. Conceivably, this may be attributed to the inhibition of the hydrophobic bonding-type attachment of a surfactant to the resin fine particles, due to the electric double layer formed by the acid groups on the surface of the resin fine particles in the aqueous medium. As described above, there has been a problem that when an aqueous dispersion of resin fine particles is intended to be obtained by using a resin having an acid group, sometimes the resulting particles have particle sizes larger than the assumed particle size.

Moreover, as has been found, in the case of a resin tending to undergo hydrolysis in emulsification as it is the case for polyester, stable production of aqueous dispersions is sometimes difficult. The present inventors infer that the increase of the amount of the acid group in the emulsification, due to the temperature and the time in the emulsification, affects the attached amount of the surfactant to the surface of the resin fine particles.

As has been found, when a resin having an acid group is dispersed in an aqueous solvent, the efficiency of the attachment of the surfactant to the surface of the resin fine particles is decreased due to the inhibition by the acid group of the attachment of the surfactant to the surface of the resin fine particles, and thus, the amount of the surfactant not contributing to the dispersion is sometimes increased in the aqueous medium. The presence of the surfactant not contributing to the dispersion, in the aqueous medium, tends to affect the production of the aggregated toner. Specifically, as has been found, during the production of the aggregated toner, the detachment of the toner-constituting component such as a wax or a pigment tends to occur, and the production of the toner having the targeted constitution is disturbed.

A toner particle having a core-shell structure including a core particle and a shell-phase has been known (herein after, referred to as the core-shell toner particle, as the case may be). When resin fine particles having large particle sizes and being insufficiently reduced in particle size are used as the resin fine particles used for forming the shell phase of the core-shell toner particle, the attachment of the resin fine particles to the core particle becomes nonuniform. The thickness of the shell phase of the toner obtained as described above becomes nonuniform, and hence the toner leads to a problem of the decrease of the storage stability. The increase of the amount of the shell may be thought up in order to solve this problem; however, as has been found, sometimes the softening point of the whole toner is increased, and the low-temperature fixability is degraded. Accordingly, in order to establish the compatibility between the storage stability and the low-temperature fixability, the particle size reduction of the resin fine particles has been found to be an important factor.

An aspect of the present invention is a method for producing an aqueous dispersion of resin fine particles, including: the steps of (A-1) preparing a mixture A by mixing a resin having an acid group, a betaine surfactant and a solvent capable of dissolving the resin; and (A-2) preparing an emulsion A by adding the mixture A into an aqueous medium, and applying shear force to the mixture A in the aqueous medium under a condition of pH=7.0 or more.

Another aspect of the present invention is a method for producing an aqueous dispersion of resin fine particles, including: (B-1) preparing a mixture B by mixing a resin having an acid group, a betaine surfactant and an aqueous medium; and (B-2) preparing an emulsion B by applying shear force to the resin in the mixture B under a condition of pH=7.0 or more and at a temperature equal to or higher than the glass transition temperature (Tg) of the resin.

The betaine surfactant in the present invention means a surfactant having a hydrophilic group such as a carboxylate group having a betaine structure. It is to be noted that the betaine structure means a structure having a positive charge and a negative charge respectively at non-adjacent positions in one and the same molecule. Specifically, a betaine surfactant is a surfactant having the structure represented by the following formula (1).

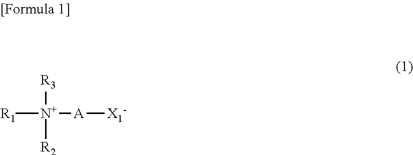

wherein in formula (1), R₁ represents a hydrophobic substituent. A hydrophobic substituent means a hydrocarbon group having a linear or branched structure or an aromatic hydrocarbon ring group such as benzene, naphthalene and anthracene. Alternatively, R₁ may have a substituent such as an amide, ester, ether, sulfide, thioether, ketone, alkene, alkane, a halogen group or a hydroxyl group. Among these, from the viewpoint of allowing the particle size distribution of the resin fine particles in the aqueous dispersion to be regulated so as to fall within a preferable range, R₁ in formula (1) is preferably amide betaine, which is a hydrophobic substituent containing an amide bond. In formula (1), R₂ and R₃ may be respectively bonded to an nitrogen atom so as to form a quaternary ammonium cation; specifically, R₂ and R₃ are respectively a hydrocarbon group having a linear or branched structure or a cyclic aromatic hydrocarbon group such as benzene, naphthalene and anthracene. Alternatively, R₂ and R₃ may each have a substituent such as an amide, ester, ether, sulfide, thioether, ketone, alkene, alkane or halogen group. Additionally, R₁, R₂ and R₃ may be bonded to each other, if necessary, to form an aromatic or non-aromatic cyclic structure.

In formula (1), A represents a hydrocarbon group. Specifically, A is preferably an alkylene group having 1 to 6 carbon atoms. In the hydrocarbon group, halogen may be substituted.

In formula (1), examples of X₁— include a carboxylic acid anion, a sulfonic acid anion and a phosphoric acid anion. In formula (1), X₁— is preferably a carboxylic acid anion, from the viewpoint of allowing the particle size of the resin fine particles in the aqueous dispersion to be regulated so as to fall within a preferable range.

Examples of the generally used betaine surfactant include lauryl betaine, laurylamidepropylbetaine, cocoamide propyl betaine, cetyl sulfobetaine, lauryl sulfobetaine, cocoamide propyl hydroxy sulfobetaine and cocoamide propyl hydroxyphosphate betaine; however, the betaine surfactant in the present invention is not limited to the aforementioned surfactants. Hereinafter, commercially available betaine surfactants are listed as examples; however, the betaine surfactant in the present invention is not limited to the following structures. NIKKOL AM-301, NIKKOL AM-3130N (the foregoing are products of Nihon Surfactant Kogyo K.K.); Amogen CB-C, Amogen CB-H, Amogen S, Amogen S-H, Amogen LB-C (the foregoing are products of Dai-ichi Kogyo Seiyaku Co., Ltd.); Amphorex LB-2, Amphorex 35N, Amphorex 50, Amphorex DB-2 (the foregoing are products of Miyoshi Oil & Fat Co., Ltd.); Enagicol CNS, Enagicol C-40H, Enagicol L-30B, Enagicol C-30B (the foregoing are products of Lion Corp.); Obazoline 662N, Obazoline 662N-SF, Obazoline BC, Obazoline CAB-30, Obazoline CS-65, Obazoline LB-SF (the foregoing are products of TOHO Chemical Industry Co., Ltd.); Genagen B 1566, Genagen B 3267, Genagen CAB 818J, Genagen DAB-J (the foregoing are products of Clariant (Japan) K.K.); Taipol Soft AMP-100, Taipol Soft AMP-300, Taipol Soft CDB-30, Taipol Soft CB-30N, Taipol Soft CMZ-30 (the foregoing are products of Taiko Oil Chmeicals Co., Ltd.); Dehyton AB-30, Dehyton K (the foregoing are products of Cognis Japan Ltd.); Marpo Bister CAP, Marpo Bister LAP, Marpo Bister MAP, Marpo Bister M (the foregoing are products of Matsumoto Yushi-Seiyaku Co., Ltd.); Rikabion A-100, Rikabion A-200, Rikabion B-200, Rikabion B-300 (the foregoing are products of New Japan Chemical Co., Ltd.); Sofdazoline LSB (the foregoing is a product of Kawaken Fine Chemicals Co., Ltd.); Amphitol 20AB, Amphitol 20BS, Amphitol 24B, Amphitol 55AB, Amphitol 86B, Amphitol 20Y-B (the foregoing are products of Kao Corporation). If necessary, the betaine surfactant may also be used in combination with an anionic surfactant or a nonionic surfactant.

In the present invention, the resin having an acid group is a resin which has a strong hydrolyzability of the molecular chain thereof or has a carboxyl group or a sulfo group, or the salt of one of these groups; specific examples of such a resin include: an acrylic acid-based resin, a methacrylic acid-based resin, a styrene-acrylic acid copolymer resin, a styrene-methacrylic acid copolymer resin, a polyester resin and a polyamide acid resin. When the resin having an acid group is used as a constituent material for toner, a polyester resin, which is capable of reducing the difference between the softening temperature (Tm) and the glass transition temperature (Tg), is preferable. The polyester resin is constituted with a constituent component derived from an acid and a constituent component derived from an alcohol; in the present invention, “the constituent component derived from an acid” means the moiety which is an acid component before the synthesis of the polyester resin, and “the constituent component derived from an alcohol” means the moiety which is an alcohol component before the synthesis of the polyester resin.

Examples of the acid component include, without being particularly limited to: the components which can impart an acid group to the main chain terminal such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, 1,18-octadecanedicaroxylic acid, terephtalic acid, isophthalic acid and phthalic acid; the components which can impart an acid group to the main chain terminal or the side chain(s) such as trimellitic acid, trimesic acid, hemimellitic acid, pyromellitic acid, benzenepentacarboxylic acid and sulfophthalic acid; and the lower alkyl esters of these acids and the anhydrides of these acids.

As the alcohol component, aliphatic diols are preferable; specific examples of such aliphatic diols include, without being particularly limited to: ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol and 1,20-eicosanediol.

The glass transition in the present invention is measured by using a differential scanning calorimeter on the basis of the following measurement method. Specifically, 10 mg of a sample is weighed out, the sample is once heated to 150° C., and cooled to room temperature at a rate of 100° C./min to remove the previous history; then, the glass transition point is calculated from the DSC curve measured when the sample is heated at a rate of 10° C./min. The central value of the intersections between the base lines before and after the heat absorption and the tangents of the curve due to heat absorption is taken as the glass transition point (° C.).

The softening temperature (Tm) is measured using a flow tester as follows. A measurement sample (resin) is weighed out in an amount of 1.5 g, and the measurement is performed using a die of 1.0 mm in height and 1.0 mm in diameter under the conditions that the temperature increase rate is 4.0° C./min, the preheating time is 300 seconds, the load is 5 kg (49 N) and the measurement temperature range is from 60.0° C. to 200.0° C. The temperature by which ½ the sample has flowed out is taken as the softening temperature (Tm).

The softening temperature (Tm) of the resin having an acid group is preferably 90.0° C. or higher and 150.0° C. or lower. Specifically, when a resin having an acid group as the constituent material of a toner, the softening temperature (Tm) of the resin having an acid group is preferably 150.0° C. or lower from the viewpoint of fixability, and 90.0° C. or higher from the viewpoint of heat-resistant storability.

The mixing step in the present invention is a step (the mixing step (A-1)) in which preparing a mixture A by mixing a resin having an acid group, a betaine surfactant and a solvent capable of dissolving the resin, or a step (the mixing step (B-1)) in which preparing a mixture B by mixing a resin having an acid group, a betaine surfactant and an aqueous medium.

The emulsification in the present invention mainly means a process for obtaining resin fine particles by imparting shear to a molten resin in a solvent mainly composed of water.

The shear in the present invention means to impart high speed motion to a mixture by applying high speed motion or pressure; examples of the emulsification apparatus include a high-speed rotary homogenizer and a high-pressure homogenizer. The high speed motion in the present invention means a shear falling within a range of 1 to 10000 m/min, and in general, such a shear is obtained by rotational motion.

The emulsification steps (A-2) and (B-2) require the mixing of a basic substance for the purpose of setting the pH of the resulting mixture at 7.0 or more. If a resin having an acid group is reduced in particle size as it is, the pH of the aqueous medium including the resin having an acid group becomes 3 to 4 to be too much on the acidic side, and thus the resin having an acid group becomes nonemulsifiable. A possible cause for this nonemulsifiability may be the polarity of the betaine surfactant unbalanced to the cationic side due to the pH change; however, no details are clear yet.

In the mixing step or the emulsification step of the present invention, an organic solvent may also be used. The solvent to be used may be either a water-soluble solvent or a non-water-soluble solvent; from the viewpoint of a factor such as the removal of the solvent and from the aspect of handling the resulting dispersion, a water-soluble solvent having a relatively low boiling point is preferable. Specifically, it is preferable to use the following solvents each alone or as mixtures thereof: ethyl acetate, butyl acetate, methyl ethyl ketone, tetrahydrofuran, dioxane, methanol, ethanol and isopropyl alcohol.

Examples of the aforementioned basic substance include: inorganic bases such as ammonia, sodium hydroxide, potassium hydroxide, sodium carbonate, potassium carbonate, sodium hydrogen carbonate and potassium hydrogen carbonate; and organic bases such as dimethylamine, diethylamine and triethylamine. Among these, from the viewpoint of the suppression of the hydrolysis under the basic condition, amines being weak bases such as dimethylamine and triethylamine are preferable.

The increase of the basic substance tends to reduce the particle size of the resin fine particles. This is probably because the acid group of the resin takes a structure of a salt to increase the self-emulsifiability of the resin. On the other hand, if the aqueous medium becomes basic, the hydrolysis of the resin sometimes occurs; accordingly, when a strong base is used as the basic substance, the addition amount of the basic substance is required to be limited so as not to cause hydrolysis. Thus, the addition amount of the basic substance is preferably 0.9 to 10.0 equivalents and more preferably 1.0 to 3.0 equivalents in relation to the number of the acid groups in the resin having an acid group.

The emulsification temperature is preferably high because the heating is performed for the purpose of decreasing the viscosity of the molten resin; however, it suffices that the emulsification temperature is a temperature at which the melt viscosity of the resin is 10³ Pa·s or less. However, a too high emulsification temperature has an aspect of promoting the hydrolysis of the resin, and hence the upper limit of the emulsification temperature is 150° C. or lower and more preferably 120° C. or lower. It is to be noted that the melt viscosity in the present invention means the melt viscosity of the resin in the aqueous medium.

Next, the emulsification method used preferably in the present invention is described in detail.

In a hermetically sealable and pressurizable vessel, a resin having an acid group is fed to an aqueous medium having a betaine surfactant and a basic substance, and successively the obtained mixture is mixed. Next, while the mixture is being heated at a temperature higher than the glass transition temperature (Tg) of the resin having an acid group under hermetic sealing and pressurization, shear force is applied to the mixture to yield a resin emulsion. Further, by cooling the obtained resin emulsion to a temperature equal to or lower than the glass transition temperature of the resin while shear force is being applied to the obtained resin emulsion, an aqueous dispersion of the resin fine particles is obtained.

When the melt viscosity of the resin having an acid group in the emulsification step exceeds 10³ Pa·s, sometimes it is difficult to obtain a resin emulsion having an intended particle size. Accordingly, the heating temperature in the emulsification step is preferably such that the shear force is applied to the mixture while the mixture is being heated at a temperature equal to or higher than the temperature at which the melt viscosity of the resin becomes 10³ Pa·s or less.

When a resin having an acid group, having a Tg of 90.0° C. or higher is used in the present invention, the heating temperature in the emulsification step is preferably 100.0° C. or higher. When the heating temperature in the emulsification step is 100.0° C. or higher, the emulsification step is preferably performed in a hermetically sealable and pressurizable vessel.

In the present invention, the cooling rate in the cooling step in which the obtained resin emulsion is cooled to a temperature equal to or lower than the Tg of the resin having an acid group while the shear force is being applied to resin emulsion is preferably 0.5° C./min or more and 10.0° C./min or less, more preferably 1.0° C./min or more and 10.0° C./min or less and furthermore preferably 1.0° C./min or more and 5.0° C./min or less. The cooling rate falling within the aforementioned range preferably facilitates the preparation of the resin fine particles having a sharp particle size distribution. When the toner particles are produced by an emulsification aggregation method, the sharp particle size distribution of the resin fine particles uniformizes the colorant in the toner particles and enables the image density obtained by printing to be improved. It is to be noted that the cooling rate from the temperature equal to or lower than the glass transition temperature (Tg) to room temperature is not particularly limited.

The resin fine particles (hereinafter, also simply referred to as the resin fine particles of the present invention) included in the aqueous dispersion of the resin fine particles, obtained by the method of the present invention, the particle size at cumulative 50% by volume is preferably 20 nm or more and 1000 nm or less and more preferably 20 nm or more and 400 nm or less.

The particle size at cumulative 50% by volume falling within the aforementioned range enables the storage stability of the resin fine particles to be improved. When such resin fine particles are used as the constituent material of the toner obtained by the emulsification and aggregation method, preferably the uniformity of the toner composition can be maintained while the particle size of the toner is being regulated to be 3 to 7 μm.

The particle size at cumulative 50% by volume of the resin fine particles regulated so as to fall within the aforementioned range can be obtained by appropriately regulating the amount of the surfactant, the amount of the basic substance, the heating temperature in the emulsification step and the strength of the shear force in each of the emulsification step and the cooling step.

In the molecular weight distribution of the resin fine particles of the present invention as measured by the gel permeation chromatography (GPC) of the tetrahydrofuran (THF)-soluble fraction of the resin fine particles, the peak top of the main peak is preferably located within a molecular weight range of 3,500 or more and 15,000 or less. The peak top of the main peak falling within the aforementioned range improves the thermal stability of the resin fine particles. An aqueous dispersion including such resin fine particles hardly causes coagulative separation even at a temperature 40° C. or higher.

The content of the component of the tetrahydrofuran (THF)-soluble fraction of the resin fine particles, having the molecular weight of 500 or more and less than 2,000 as measured by gel permeation chromatography (GPC), is preferably 0.1% or more and 20.0% or less of the total component amount and more preferably 0.1% or more and 15.0% or less of the total component amount. The content of the component having a molecular weight of 500 or more and less than 2,000 falling within the aforementioned range improves the powder properties and, in particular, the thermal stability of the toner obtained by using such resin fine particles.

The solvent in which the resin in the present invention is soluble is preferably a solvent capable of completely dissolving 10 parts by mass of the resin in 100 parts by mass of the solvent in the range from room temperature to the emulsification temperature. The solvent may be either a water-soluble solvent or a non-water-soluble solvent; however, from the viewpoint of a factor such as the removal of the solvent and from the aspect of handling the resulting dispersion, a water-soluble solvent having a relatively low boiling point is preferable. Specifically, it is preferable to use the following solvents each alone or as mixtures thereof: ethyl acetate, butyl acetate, methyl ethyl ketone, tetrahydrofuran, dioxane, methanol, ethanol and isopropyl alcohol.

The mechanism yielding resin fine particles having small particle sizes by using the betaine surfactant in the present invention is not definitely clear; however, the aforementioned mechanism is inferred at present as follows.

As is widely known, when the emulsification of the resin having an acid group is performed by using an anionic surfactant under the condition of pH=7.0 or more, the acid group of the resin having an acid group forms a salt structure, and an electric double layer is formed on the surface of the resin particles. The diligent study of the present inventors has revealed that the electric double layer inhibits the attachment of the surfactant to the resin due to the hydrophobic bonding as the driving force, and hence sometimes the effect of the surfactant cannot be sufficiently displayed. However, in the case of the betaine surfactant, this surfactant ionically interacts, through the presence of the positively charged quaternary amine salt in the surfactant, with the carboxylic acid on the surface of the resin fine particles including the resin having an acid group to form weak bonds as the case may be. Consequently, it is understood that in the case of the betaine surfactant, the betaine surfactant can be adsorbed to the surface of the resin without being inhibited by the electric double layer, and thus the emulsification is allowed to proceed.

<Method for Producing Toner>

Hereinafter, a method for producing a toner, using the aqueous dispersion of the resin fine particles obtained by the aforementioned production method is described.

Another aspect of the present invention is a method for producing a toner including toner particles each of which includes a binder resin and a colorant, wherein the toner particles are obtained by: aggregating the resin fine particles and the colorant in the aqueous medium, after the aqueous dispersion of resin fine particles produced by the above method and a colorant are mixed, to obtain an aqueous dispersion of aggregates; and fusing the aggregates by heating the aqueous dispersion of the aggregates. The formation of the toner particle by aggregating and coalescing such resin fine particles improves the thermal stability. When the peak top of the main peak of the molecular weight distribution of the resin fine particles is located within a molecular weight range of 3,500 or more and 15,000 or less, the low-temperature fixability of the toner obtained by using such resin fine particles is improved. Similarly, when the weight average molecular weight Mw of the tetrahydrofuran (THF)-soluble fraction of the resin fine particles as measured by gel permeation chromatography (GPC) is preferably 5,000 or more and 50,000 or less, and more preferably by setting this molecular weight at 5,000 or more and 30,000 or less, the low-temperature fixability is improved.

<Aggregation Step>

The aggregation step is a step in which the foregoing aqueous dispersion of the resin fine particles and a colorant are mixed, the resin fine particles and the colorant are aggregated in the aqueous medium, and thus an aqueous dispersion of aggregates containing the aggregates is obtained. Here, the colorant may also be mixed, in the state of an aqueous dispersion of the colorant obtained by dispersing the colorant in an aqueous medium, with the aqueous dispersion of the resin fine particles. When the aqueous dispersion of the resin fine particles and the colorant are mixed, the constituent component(s) of the toner such as a release agent may also be added. Examples of the method for forming the aggregates include a method in which an aggregating agent is added to and mixed with the mixed solution of the resin fine particles and the colorant, and the resulting mixture is appropriately heated and mechanical power is appropriately applied to the resulting mixture.

The colorant mat be either a pigment or a dye; however, from the viewpoint of light resistance, the colorant is preferably a pigment. Examples of the pigment in the present invention include a water-insoluble organic color material or a water-insoluble inorganic color material.

Examples of the inorganic color material include: oxide pigments such as cobalt blue, celsian blue, cobalt violet, cobalt green, zinc white, titanium white, light red, chromium oxide green and mars black; hydroxide pigments such as viridian, yellow ocher and alumina white; silicate pigments such as ultramarine, talc and white carbon; metal powders such as gold powder, silver powder and bronze powder; and carbon black.

Examples of the organic color material include: azo compounds such as β-naphthol azo compounds, naphthol AS azo compounds, monoazo type or diazo type acetoacetic acid allylide azo compounds, pyrazon azo compounds and condensation azo pigments; phthalocyanine compounds, subphthalocyanine compounds, porphyrin compounds, quinacridone compounds, isoindoline compounds, isoindolinone compounds, threne compounds, perylene compounds, perinone compounds, thioindigo compounds, dioxazine compounds, quinophthalone compounds, diketopyrrolopyrrole compounds and newly synthesized compounds.

The pigments used in the present invention are not limited to the aforementioned examples. Hereinafter, commercially available color materials of black, cyan, magenta and yellow are listed as the examples.

Examples of black color materials include: Raven1060, Raven1080, Raven1170, Raven1200, Raven1250, Raven1255, Raven1500, Raven2000, Raven3500, Raven5250, Raven5750, Raven7000, Raven5000 ULTRA II and Raven1190 ULTRA II (the foregoing are manufactured by Columbian Chemicals Company); Black Pearls L, MOGUL-L, Regal400R, Regal660R, Regal330R, Monarch 800, Monarch 880, Monarch 900, Monarch 1000, Monarch 1300 and Monarch 1400 (the foregoing are manufactured by Cabot Corporation); Color Black FW1, Color Black FW2, Color Black FW200, Color Black 18, Color Black S160, Color Black S170, Special Black 4, Special Black 4A, Special Black 6, Printex35, PrintexU, Printex140U, PrintexV and Printex140V (the foregoing are manufactured by Degussa AG); No. 25, No. 33, No. 40, No. 47. No. 52, No 900, No. 2300, MCF-88, MA600, MA7, MA8 and MA100 (the foregoing are manufactured by Mitsubishi Chemical Corp.).

Examples of the cyan color materials include: C.I. Pigment Blue-1, C.I. Pigment Blue-2, C.I. Pigment Blue-3, C.I. Pigment Blue-15, C.I. Pigment Blue-15:2, C.I. Pigment Blue-15:3, C.I. Pigment Blue-15:4, C.I. Pigment Blue-16, C.I. Pigment Blue-22 and C.I. Pigment Blue-60.

Examples of the magenta color materials include: C.I. Pigment Red-5, C.I. Pigment Red-7, C.I. Pigment Red-12, C.I. Pigment Red-48, C.I. Pigment Red-48:1, C.I. Pigment Red-57, C.I. Pigment Red-112, C.I. Pigment Red-122, C.I. Pigment Red-123, C.I. Pigment Red-146, C.I. Pigment Red-168, C.I. Pigment Red-184, C.I. Pigment Red-202 and C.I. Pigment Red-207.

Examples of the yellow color materials include: C.I. Pigment Yellow-12, C.I. Pigment Yellow-13, C.I. Pigment Yellow-14, C.I. Pigment Yellow-16, C.I. Pigment Yellow-17, C.I. Pigment Yellow-74, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154.

Examples of the release agent include: low molecular weight polyolefins such as polyethylene; silicones having softening point; fatty acid amides such as oleic acid amide, erucic acid amide, recinoleic acid amide and stearic acid amide; ester waxes such as stearyl stearate; plant-based waxes such as carnauba wax, rice wax, candelilla wax, Japan wax and jojoba oil; animal-based waxes such as bees wax; mineral/petroleum-based waxes such as montan wax; ozokerite; ceresin; paraffin wax; microcrystalline wax; Fischer-Tropsch wax and ester wax; and the modified products of these.

A charge controlling agent may be added to the toner of the present invention, if necessary. As the charge controlling agent, the following can be used: chromium-based azo dyes; iron-based azo dyes, aluminum-based azo dyes, salicylic acid metal complexes and polymer-based charge controlling agents.

Examples of the aggregating agent include: metal salts of monovalent metals such as sodium and potassium; metal salts of divalent metals such as calcium and magnesium; and metal salts of trivalent metals such as iron and aluminum.

The addition and mixing of the aggregating agent is preferably performed at a temperature equal to or lower than the glass transition temperature (Tg) of the resin particles included in the mixed solution. When the mixing is performed under this temperature condition, aggregation proceeds in a stable manner. The mixing can be performed by using heretofore known mixing apparatuses, a homogenizer, a mixer and the like.

The average particle size of the aggregates formed in this case is not particularly limited; however, usually, the average particle size of the aggregates may be controlled so as to be approximately the same as the average particle size of the toner particles to be obtained. The control of the particle size of the aggregate can be easily performed by appropriately setting/changing the temperature at the time of adding/mixing of the aggregating agent and the stirring and mixing conditions.

The average particle size of the aggregates can be obtained by using the Coulter counter (TA-II type, manufactured by Beckman Coulter, Inc.) and by measuring with an aperture diameter of 50 μm. In this case, the average particle size of the aggregates was obtained by performing the measurement after dispersing the toner in an electrolyte aqueous solution (isotonic aqueous solution), and dispersing the toner for 30 seconds or more with an ultrasonic cleaner.

The average particle size of the resin fine particles can be measured by using dynamic light scattering (DLS), laser scattering, the centrifugal sedimentation method, the field-flow fractionation method, and the electric detector method. The average particle size of the resin fine particles in the present invention means, unless otherwise specified, the cumulative 50% particle size (d50) measured by DLS, in particular, the microtrac method at 20° C. with a solid content concentration of 0.01% by mass.

<Fusion Step>

The fusion step is a step of fusing the aggregates by heating the aqueous dispersion of the aggregates. In this case, by fusing the aggregated by heating the aggregates at a temperature equal to or higher than the glass transition point (Tg) of the resin having an acid group, core particles with the smoothed aggregate surface can be preferably obtained. By performing the fusion step, the surface area of the aggregates is reduced, and when the shell phase is formed, the resin fine particles for the shell can be efficiently attached. Before entering into the fusion step, for the purpose of preventing the fusion between the toner particles, a chelating agent, a pH adjuster and a surfactant may be appropriately placed in the aqueous dispersion of the aggregates. Alternatively, the present fusion step may be performed as a primary fusion step, and the below-described secondary fusion step may further be performed.

Examples of the chelating agent include: ethylenediamine tetraacetic acid (EDTA) and alkali metal salts such as Na salt of ethylenediamine tetraacetic acid, sodium gluconate, sodium tartarate, potassium citrate, sodium citrate, nitrotriacetate (NTA) salts, and a large number of water-soluble polymers (polyelectrolytes) including both of the functional groups COOH and OH.

The heating temperature in the fusion step may fall between the glass transition temperature (Tg) of the resin having an acid group included in the aggregates and the thermal decomposition temperature of the resin having an acid group. The heating fusion time is sufficiently a short time when the heating temperature is high, and is required to be long when the heating temperature is low. In other words, the heating fusion time depends on the heating temperature, and hence cannot be specified unconditionally; however, in general, the heating fusion time is 10 minutes to 10 hours. After the fusion step, if necessary, the following cooling step may be added.

<Cooling Step>

The cooling step is a step of cooling the temperature of the aqueous medium containing the core particles to a temperature lower than the glass transition point (Tg) of the resin having an acid group. If the cooling is not performed at a temperature lower than Tg, in the further formation of the shell phase after the cooling, the addition of the aggregating agent in the shell phase formation step tends to cause the occurrence of coarse particles. Specifically, the cooling rate is preferably 0.1 to 50° C./min.

Next, a method for producing a toner is described in which at the time of formation of a shell phase, in the core-shell toner particle having a core particle containing a binder resin and a colorant and having the shell phase formed on the surface of the core particle, the aqueous dispersion of the resin fine particles obtained in the aforementioned production method is used. An aspect of the present invention is a method for producing a toner, wherein the toner particles are obtained by forming a shell phase by attaching the resin fine particles in the aqueous dispersion of resin fine particles produced by the aforementioned method to the core particle. In the present invention, examples of the method for producing the core particle used in the formation of the shell-phase include, without being particularly limited to, a production method performed by passing through the aggregation step and the fusion step.

<Shell Phase Formation Step>

The shell-phase formation step is a step of forming the shell phase by attaching to the core particle the resin fine particles in the aqueous dispersion of the resin fine particles. In this case, preferably, at a temperature lower than the glass transition point (Tg) of the binder resin, the aqueous dispersion of the resin fine particles including the resin having an acid group, to be used for forming the shell phase, and the aggregating agent are mixed, and thus the resin fine particles including the resin having an acid group are attached to the core particle. The shell-phase formation step is performed next to the cooling step. Specifically, after the cooling step, the core particles are filtered from the aqueous medium containing the core particles, and then the shell-phase formation step can be performed without redispersing the core particles.

Examples of the aggregating agent include: metal salts of monovalent metals such as sodium and potassium; metal salts of divalent metals such as calcium and magnesium; and metal salts of trivalent metals such as iron and aluminum. The aggregating agent may be mixed simultaneously with the aqueous dispersion of the resin fine particles, or before or after the mixing of the aqueous dispersion of the resin fine particles. After the attachment of the resin fine particles to the core particles, the following secondary fusion step, and the cleaning step and the cooling step may be performed, if necessary.

<Secondary Fusion Step>

The secondary fusion step is a step of smoothing the surface of the toner particles by heating the resin fine particles to a temperature equal to or higher than the glass transition point (Tg) of the resin having an acid group so as to fuse the shell-coated particles. By performing the secondary fusion step, the binder resin and the resin fine particles for the shell are sufficiently bound to each other to suppress the detachment of the shell phase from the toner. Before performing the secondary fusion step, for the purpose of preventing the fusion between the toner particles, a chelating agent, a pH adjuster and a surfactant may be appropriately placed.

The heating temperature in the secondary fusion step may fall between the glass transition temperature (Tg) of the resin having an acid group included in the aggregates and the thermal decomposition temperature of the resin having an acid group. The heating fusion time is sufficiently a short time when the heating temperature is high, and is required to be long when the heating temperature is low. In other words, the heating fusion time depends on the heating temperature, and hence cannot be specified unconditionally; however, in general, the heating fusion time is 10 minutes to 10 hours.

After the completion of the secondary fusion step, the obtained toner is cooled to room temperature under appropriate conditions, then cleaned, filtered and dried to yield toner particles. Further, to the surface of the obtained toner particles, inorganic powders such as silica, alumina, titania and calcium carbonate, and particles of the resins such as vinyl resin, polyester resin and silicone resin may be added by applying shear force under dry conditions. These inorganic powders and resin particles function as external additives such as fluidity aids or cleaning aids.

The weight average particle size (D4) of the toner particles obtained by the present invention is preferably 4.5 to 7.0 μm and more preferably 5.0 to 6.5 μm. The weight average particle size of the toner particles falling within the aforementioned range enables, while the resolution of the obtained images is being lowered, the charge distribution extension due to the fluidity degradation to be suppressed, and the fogging in the background and the toner fall out of the developing unit to be also suppressed.

### EXAMPLES

Hereinafter, the present invention is described in detail with reference to Examples; however, the present invention is not limited to these Examples. It is to be noted that the term “parts” in the following compositions means “parts by mass” unless otherwise specified.

First, the analysis methods of various particles are described.

<Measurement of Molecular Weight Distribution, Weight Average Molecular Weight (Mw) and Number Average Molecular Weight (Mn) Measured by Gel Permeation Chromatography (GPC) of Tetrahydrofuran (THF)-Soluble Fraction of Resin>

The molecular weight distribution, weight average molecular weight (Mw) and number average molecular weight (Mn) measured by the gel permeation chromatography (GPC) of the THF-soluble fraction of the resin are determined as follows.

Columns are stabilized in a heat chamber set at 40° C., tetrahydrofuran (THF) as the solvent is made to flow in these columns set at this temperature at a flow rate of 1 ml/min, and about 10 μl of a THF sample solution is injected to perform the measurement. When the molecular weight of a sample is measured, the molecular weight distribution possessed by the sample is derived from the relation between the logarithmic value of the calibration curve prepared with several types of monodispersion polystyrene standard samples and the number of counts. As the standard polystyrene samples for preparation of the calibration curve, standard polystyrene samples having molecular weights of about 10² to 10⁷, manufactured by, for example, Tohso Corp. or Showa Denko K.K. are used, and it is appropriate to use at least about ten different standard polystyrene samples. For the detector, an RI (refractive index) detector is used. As the columns, a plurality of commercially available polystyrene gel columns may be successfully used in combination; examples of such a combination of the columns include: a combination of Shodex GPC KF-801, 802, 803, 804, 805, 806, 807 and 800P manufactured by Showa Denko K.K.; and a combination of TSK gel G1000H(HXL), G2000H(HXL), G3000H(HXL), G4000H(HXL), G5000H(HXL), G6000H(HXL), G7000H(HXL) and TSK guard column manufactured by Tohso Corp.

The sample is prepared as follows.

A resin (a sample) is placed in tetrahydrofuran (THF), allowed to stand for a few hours, then sufficiently shaken to be well mixed with THF (until the coalescent matter of the sample disappears), and then allowed to stand still for further 12 hours or more. In this case, the time during which the sample is allowed to stand in THF is set to be 24 hours or more. Then, the filtrate obtained by allowing the THF sample solution pass through a sample treatment filter (pore size: 0.45 to 0.5 μm, for example, Maishori-disk H-25-5, manufactured by Tohso Corp., or Ekikuro-disk 25CR, manufactured by German Science Japan Co., Ltd. can be used) is used as a sample for GPC. The sample concentration is regulated so as for the resin component to be 0.5 to 5 mg/ml.

From the prepared molecular weight distribution, the molecular weight (Mp) corresponding to the peak top of the main peak and the amount of the component corresponding to the molecular weight of 500 or more and less than 2,000 in relation to the total component amount can be derived. The amount of the component corresponding to the molecular weight of 500 or more and less than 2,000 in relation to the total component amount can be calculated by subtracting the frequency distribution cumulative value up to 500 from the frequency distribution cumulative value up to 2000.

<Measurement of Acid Number of Resin>

The acid number of a resin is determined as follows. The basic operations are based on JIS-K0070. The acid number means the number of milligrams of potassium hydroxide required to neutralize the free fatty acid, resin acid and the like contained in 1 g of the resin in the sample.

(1) Reagents

(a) Solvent: An ethyl ether-ethyl alcohol mixed solution (1+1 or 2+1) or a benzene-ethyl alcohol mixed solution (1+1 or 2+1) is neutralized immediately before the use with a N/10 potassium hydroxide ethyl alcohol solution by using phenolphthalein as an indicator.

(b) Phenolphthalein solution: Phenolphthalein (1 g) is dissolved in 100 ml of ethyl alcohol (95 v/v %).

(c) 0.1 mol/L Ethyl alcohol solution of potassium hydroxide:potassium hydroxide (7.0 g) is dissolved in an as small as possible amount of water, ethyl alcohol (95 v/v %) is added to this aqueous solution to prepare a 1 liter solution, and the resulting solution is allowed to stand for 2 to 3 days and then filtered. The filtrate is standardized according to JIS K 8006 (basic items concerning neutralization titration in testing the content of a reagent).

(2) Operation

As the sample, a resin particle dispersion or a resin is accurately weighed so as for the amount of the resin in the sample to be 1 to 20 g; to the weighed sample, 100 ml of the solvent and a few drops of the phenolphthalein solution as the indicator are added, and the resulting mixture is sufficiently shaken until the sample is completely dissolved. In the case of a solid sample, the sample is dissolved by heating on a water bath. After cooling, the resulting sample solution is titrated with 0.1 mol/L ethyl alcohol solution of potassium hydroxide, and the time point when the pink color of the indicator continues for 30 seconds is taken as the end point of the neutralization.

(3) Calculation Formula

On the basis of the following formula, the acid number is calculated.

A=B×f×5.611/S

A: Acid number

B: The addition amount (ml) of 0.1 mol/L ethyl alcohol solution of potassium hydroxide

f: The factor of the 0.1 mol/L ethyl alcohol solution of potassium hydroxide

S: The amount (g) of the resin in the sample

<Measurement of Average Particle Sizes of Resin Fine Particles and Colorant Fine Particles>

For the analysis of the average particle size, a laser diffraction/scattering particle size distribution analyzer (manufactured by Horiba, Ltd., LA-950) is used, and the measurement is performed according to the operation manual of this analyzer. After dropwise addition of a surfactant aqueous solution to the circulating water, a release agent particle dispersion is dropwise added to the optimal concentration of the apparatus and dispersed for 30 seconds with ultrasonic wave, and then the measurement is started to determine the median diameter based on volume. The median diameter based on volume was taken as the average particle size of the resin fine particles or the colorant fine particles.

<Measurement of Weight Average Particle Size of Toner Particles>

The weight average particle size (D4) of the toner particles is measured by the particle size distribution analysis based on the Coulter method. As the measurement apparatus, the Coulter counter TA-II or the Coulter Multisizer II (manufactured by Beckman Coulter, Inc.) is used, and the measurement is performed according to the operation manual of the apparatus. The electrolyte solution is prepared by using first grade sodium chloride, as an about 1% aqueous solution of sodium chloride. As the electrolyte solution, for example, ISOTON-II (manufactured by Coulter Scientific Japan Co., Ltd.) can be used. The specific measurement method is as follows: in 100 to 150 ml of the aqueous electrolyte solution, 0.1 to 5 ml of a surfactant (preferably, an alkylbenzenesulfonic acid salt) as a dispersant is added, and further, 2 to 20 mg of the measurement sample (toner particles) is added. The electrolyte solution in which the sample is suspended is subject to dispersion treatment for about 1 to 3 minutes with a supersonic disperser. For the obtained dispersion-treated solution, the volume and the number of the toner particles of 2.00 μm or more are measured by using the forgoing measurement apparatus equipped with a 100 μm aperture as an aperture, and thus, the volume distribution and the number distribution of the toner particles are calculated. From the calculated results, the weight average particle size (D4) of the toner particles is determined.

<Measurement of Glass Transition Point (Tg) of Resin>

The glass transition point (Tg) of a resin can be measured by using a differential scanning calorimeter (DSC). In the measurement with a DSC, from viewpoint of the measurement principle, measurement is preferably performed with a high precision internal heating input compensation-type differential scanning calorimeter. The measurement is performed on the basis of the measurement method according to ASTM D3418-82. Specifically, after the previous thermal history is removed by once heating and cooling the sample, Tg is calculated from the DSC curve measured when the sample is heated at a rate of 10° C./min. The central value of the intersections between the base lines before and after the heat absorption and the tangents of the curve due to heat absorption is taken as Tg (° C.).

Hereinafter, Examples according to the production of the aqueous dispersion of resin fine particles of the present invention are presented.

<<Production of Aqueous Dispersion of Resin Fine Particles>>

### Resin Production Example 1

In a three neck flask, 50 parts of polyoxypropylene (2.2)-2,2-bis(4-hydroxyphenyl)propane, 28 parts of terephthalic acid, 20 parts of isophthalic acid and 0.03 part of dibutyltin oxide were placed, the resulting mixture was stirred at 230° C. for 24 hours in a flow of nitrogen gas, then 2 parts of trimellitic acid was added to the mixture, and the mixture was stirred at 200° C. for 1 hour. Then, the mixture was stirred under a reduced pressure of 3 mmHg for 4 hours while the temperature was being maintained, to yield a polyester resin 1 having a Mw of 20,500, a Mn of 7,200, a Tg of 71° C. and an acid number of 9.0 mg KOH/g.

### Resin Production Example 2

In a three neck flask, 50 parts of polyoxypropylene (2.2)-2,2-bis(4-hydroxyphenyl)propane, 28 parts of terephthalic acid, 20 parts of isophthalic acid, and 0.03 part of dibutyltin oxide were placed, the resulting mixture was stirred at 230° C. for 24 hours in a flow of nitrogen gas, then 1 part of trimellitic acid was added to the mixture, and the mixture was stirred at 200° C. for 1 hour. Then, the mixture was stirred under a reduced pressure of 1 mmHg for 4 hours, to yield a polyester resin 2 having a Mw of 21,500, a Mn of 7,400, a Tg of 73° C. and an acid number of 2.0 mg KOH/g.

### Resin Production Example 3

In a three neck flask, 50 parts of polyoxypropylene (2.2)-2,2-bis(4-hydroxyphenyl)propane, 28 parts of terephthalic acid, 20 parts of isophthalic acid and 0.03 part of dibutyltin oxide were placed, the resulting mixture was stirred at 230° C. for 24 hours in a flow of nitrogen gas, then 3 parts of trimellitic acid was added to the mixture, and the mixture was stirred at 200° C. for 30 min. Then, the mixture was stirred under a reduced pressure of 5 mmHg for 2 hours while the temperature was being maintained, to yield a polyester resin 3 having a Mw of 22,500, a Mn of 7,200, a Tg of 72° C. and an acid number of 20.0 mg KOH/g.

### Resin Production Example 4

In a three neck flask, 50 parts of polyoxypropylene (2.2)-2,2-bis(4-hydroxyphenyl)propane, 28 parts of terephthalic acid, 20 parts of isophthalic acid and 0.03 part of dibutyltin oxide were placed, the resulting mixture was stirred at 230° C. for 24 hours in a flow of nitrogen gas, then 4 parts of trimellitic acid was added to the mixture, and the mixture was stirred at 200° C. for 30 min. Then, the mixture was stirred under a reduced pressure of 5 mmHg for 1 hours while the temperature was being maintained, to yield a polyester resin 4 having a Mw of 23,500, a Mn of 6,800, a Tg of 71° C. and an acid number of 30.0 mg KOH/g.

### Resin Production Example 5

In a three neck flask, 25 parts of polyoxypropylene (2.2)-2,2-bis(4-hydroxyphenyl)propane, 25 parts of polyoxyethylene(2.2)-2,2-bis(4-hydroxyphenyl)propane, 20 parts of terephthalic acid, 30 parts of fumaric acid and 0.03 part of dibutyltin oxide were placed, the resulting mixture was stirred at 230° C. for hours in a flow of nitrogen gas, then 4 parts of trimellitic acid was added to the mixture, and the mixture was stirred at 200° C. for 30 min. Then, the mixture was stirred under a reduced pressure of 5 mmHg for 1 hours while the temperature was being maintained, to yield a polyester resin 5 having a Mw of 10,500, a Mn of 3,200, a Tg of 52° C. and an acid number of 15.0 mg KOH/g.

### Example 1

In 150 parts of ion exchange water (aqueous medium), 90 parts of Amogen LB-C (manufactured by Dai-ichi Kogyo Seiyaku Co., Ltd., solid content: 30% by mass), which is a carbobetaine having an amide bond, as a betaine surfactant and 10 parts of N,N-dimethylaminoethanol (basic substance, corresponding to 1.5 equivalents in relation to the acid number) were dissolved to prepare a dispersion medium liquid. In a 350-ml stainless steel round-bottom pressure vessel, 270 g of the dispersion medium liquid was placed, and then 100 parts of a pulverized product (particle size: 1 to 2 mm) of the aforementioned polyester resin 1 was placed, and the resulting mixture was mixed.

Next, a high-speed shear emulsification apparatus Clearmix (CLM-2.2S, manufactured by M Technique Co., Ltd.) was hermetically joined to the stainless steel round-bottom pressure vessel. The temperature of the mixture in the vessel was set at 140° C., the rotor rotation number of the Clearmix was set at 20,000 rpm, and then the mixture in the vessel was shear-dispersed at 140° C. for 20 minutes. Then, while the rotation at 20,000 rpm was being maintained, the mixture was cooled at a cooling rate of 10.0° C./min until the temperature of the mixture reached 50.0° C., to yield an aqueous dispersion (1) of resin fine particles, having an acid number of 12.0 mg KOH/g, an average particle size of 105 nm and a pH of 7.5.

### Example 2

In 150 parts of ion exchange water (aqueous medium), 90 parts of Amogen LB-C (manufactured by Dai-ichi Kogyo Seiyaku Co., Ltd., solid content: 30% by mass) as a betaine surfactant and 10 parts of N,N-dimethylaminoethanol (basic substance, corresponding to 1.5 equivalents in relation to the acid number) were dissolved to prepare a dispersion medium liquid. Then, 100 parts of a pulverized product (particle size: 1 to 2 mm) of the polyester resin 1 was dissolved in 100 parts of tetrahydrofuran to prepare a resin solution. The dispersion medium liquid was dropwise added at a rate of 10 ml/min to the resin solution while the resin solution was being stirred with a stirring blade, then the tetrahydrofuran was distilled off with an evaporator, to yield an aqueous dispersion (2) of resin fine particles, having an acid number of 10.0 mg KOH/g, an average particle size of 97 nm and a pH of 7.5.

### Example 3

After 90 parts of Amogen LB-C (manufactured by Dai-ichi Kogyo Seiyaku Co., Ltd., solid content: 30% by mass) as a betaine surfactant and 100 parts of the pulverized product (particle size: 1 to 2 mm) of the polyester resin 1 were mixed, the resulting mixture was mixed under stirring at 97° C. to yield a resin melt solution. Next, 10 parts of N,N-dimethylaminoethanol (basic substance, corresponding to 1.5 equivalents in relation to the acid number) was dissolved in 150 parts of ion exchange water (aqueous medium) to prepare an alkaline solution. The alkaline solution was dropwise added at a rate of 10 ml/min to the resin melt solution while the resin melt solution was being stirred with a stirring blade, to yield an aqueous dispersion (3) of resin fine particles, having an acid number of 14.0 mg KOH/g, an average particle size of 125 nm and a pH of 7.4.

### Example 4

An aqueous dispersion (4) of resin fine particles, having an acid number of 10.0 mg KOH/g, an average particle size of 108 nm and a pH of 7.1 was obtained in the same manner as in Example 1 except that the amount of N,N-dimethylaminoethanol was altered to 7.0 parts (corresponding to 1.0 equivalent in relation to the acid number).

### Example 5

An aqueous dispersion (5) of resin fine particles, having an acid number of 12.0 mg KOH/g, an average particle size of 250 nm and a pH of 7.5 was obtained in the same manner as in Example 1 except that the addition amount of Amogen LB-C (manufactured by Dai-ichi Kogyo Seiyaku Co., Ltd.) as a betaine surfactant was set at 0.15 part, which was approximately equivalent to the critical micelle concentration (CMC). Here, it is to be noted that the CMC of Amogen LB-C is 2.0 mM.

### Example 6

An aqueous dispersion (6) of resin fine particles, having an acid number of 12.0 mg KOH/g, an average particle size of 115 nm and a pH of 7.5 was obtained in the same manner as in Example 1 except that the addition amount of Amogen LB-C (manufactured by Dai-ichi Kogyo Seiyaku Co., Ltd.) as a betaine surfactant was set at 30 parts.

### Example 7

An aqueous dispersion (7) of resin fine particles, having an acid number of 12.0 mg KOH/g, an average particle size of 95 nm and a pH of 7.5 was obtained in the same manner as in Example 1 except that the addition amount of Amogen LB-C (manufactured by Dai-ichi Kogyo Seiyaku Co., Ltd.) as a betaine surfactant was set at 120 parts.

### Example 8

An aqueous dispersion (8) of resin fine particles, having an acid number of 12.0 mg KOH/g, an average particle size of 110 nm and a pH of 7.5 was obtained in the same manner as in Example 1 except that Sofdazoline LSB (manufactured by Kawaken Fine Chemicals Co., Ltd., solid content: 30% by mass), which is a sulfobetaine having a amide bond, was used as a betaine surfactant.

### Example 9

An aqueous dispersion (9) of resin fine particles, having an acid number of 12.0 mg KOH/g, an average particle size of 115 nm and a pH of 7.5 was obtained in the same manner as in Example 1 except that Amogen S-H (manufactured by Dai-ichi Kogyo Seiyaku Co., Ltd., solid content: 30% by mass), which is a carbobetaine containing no amide bond, was used as a betaine surfactant.

### Example 10

An aqueous dispersion (10) of resin fine particles, having an acid number of 12.0 mg KOH/g, an average particle size of 110 nm and a pH of 7.5 was obtained in the same manner as in Example 1 except that dodecyldimethyl (3-sulfopropyl) ammonium hydroxide inner salt (Tokyo Chemical Industry Co., Ltd.), which is a sulfobetaine containing no amide bond, was used as a betaine surfactant, in an addition amount of 30 parts.

### Example 11

An aqueous dispersion (11) of resin fine particles, having an acid number of 12.0 mg KOH/g, an average particle size of 125 nm and a pH of 7.5 was obtained in the same manner as in Example 1 except that 3-(dimethyloctadecylammonio) propanesulfonate (Tokyo Chemical Industry Co., Ltd.), which is a sulfobetaine containing no amide bond, was used as a betaine surfactant, in an addition amount of 30 parts.

### Example 12

An aqueous dispersion (12) of resin fine particles, having an acid number of 3.0 mg KOH/g, an average particle size of 130 nm and a pH of 7.5 was obtained in the same manner as in Example 1 except that polyester resin 2 was used as the resin and the addition amount of N,N-dimethylaminoethanol (basic substance) was set at 2.2 parts.

### Example 13

An aqueous dispersion (13) of resin fine particles, having an acid number of 25 mg KOH/g, an average particle size of 95 nm and a pH of 7.5 was obtained in the same manner as in Example 1 except that polyester resin 3 was used as the resin and the addition amount of N,N-dimethylaminoethanol (basic substance) was set at 22 parts.

### Example 14

An aqueous dispersion (14) of resin fine particles, having an acid number of 37 mg KOH/g, an average particle size of 82 nm and a pH of 7.5 was obtained in the same manner as in Example 1 except that polyester resin 4 was used as the resin and the addition amount of N,N-dimethylaminoethanol (basic substance) was set at 33 parts.

### Example 15

An aqueous dispersion (15) of resin fine particles, having an acid number of 18 mg KOH/g, an average particle size of 102 nm and a pH of 7.5 was obtained in the same manner as in Example 1 except that the emulsification temperature was set at 120° C., polyester resin 5 was used as the resin and the addition amount of N,N-dimethylaminoethanol (basic substance) was set at 17 parts.

### Example 16

An aqueous dispersion (16) of resin fine particles, having an acid number of 18 mg KOH/g, an average particle size of 155 nm and a pH of 7.5 was obtained in the same manner as in Example 1 except that the addition amount of Amogen LB-C (manufactured by Dai-ichi Kogyo Seiyaku Co., Ltd.) as a betaine surfactant was set at 15 parts.

### Example 17

An aqueous dispersion (17) of resin fine particles, having an acid number of 9 mg KOH/g, an average particle size of 130 nm and a pH of 7.5 was obtained in the same manner as in Example 1 except that a styrene-acrylic acid copolymer having an acid number of 9 mg KOH/g was used as the resin and the emulsification temperature was set at 190° C.

### Example 18

An aqueous dispersion (18) of resin fine particles, having an acid number of 3.0 mg KOH/g, an average particle size of 137 nm and a pH of 7.5 was obtained in the same manner as in Example 12 except that a styrene-acrylic acid copolymer having an acid number of 3.0 mg KOH/g was used as the resin and the emulsification temperature was set at 190° C.

### Example 19

An aqueous dispersion (19) of resin fine particles, having an acid number of 21 mg KOH/g, an average particle size of 105 nm and a pH of 7.5 was obtained in the same manner as in Example 13 except that a styrene-acrylic acid copolymer having an acid number of 20.0 mg KOH/g was used as the resin and the emulsification temperature was set at 190° C.

### Example 20

An aqueous dispersion (20) of resin fine particles, having an acid number of 17 mg KOH/g, an average particle size of 230 nm and a pH of 7.5 was obtained in the same manner as in Example 15 except that the used amount of the betaine surfactant was set at 5 parts.

### Comparative Example 1

An aqueous dispersion (21) of resin fine particles, having an acid number of 12.0 mg KOH/g, an average particle size of 272 nm and a pH of 7.5 was obtained in the same manner as in Example 1 except that sodium dodecylbenzenesulfonate, which is an anionic emulsifier, was used in place of the betaine surfactant.

### Comparative Example 2

An aqueous dispersion (22) of resin fine particles, having an acid number of 12.0 mg KOH/g, an average particle size of 572 nm and a pH of 7.5 was obtained in the same manner as in Example 1 except that Sofdazoline-LAO (manufactured by Kawaken Fine Chemicals Co., Ltd., solid content: 30% by mass), which is an amphoteric emulsifier, was used in place of the betaine surfactant.

### Comparative Example 3

The emulsification was tried in the same manner as in Example 1 except that Catiogen TMS (manufactured by Dai-ichi Kogyo Seiyaku Co., Ltd., solid content: 30% by mass), which is a cationic emulsifier, was used in place of the betaine surfactant; however, the resin fine particles turned into solid mass and no aqueous dispersion of resin fine particles was able to be produced.

### Comparative Example 4

An aqueous dispersion (23) of resin fine particles, having an acid number of 10.0 mg KOH/g, a particle size of 125 nm and a pH of 7.5 was obtained in the same manner as in Example 2 except that sodium dodecylbenzenesulfonate, which is an anionic emulsifier, was used in place of the betaine surfactant.

### Comparative Example 5

An aqueous dispersion (24) of resin fine particles, having an acid number of 14.0 mg KOH/g, a particle size of 137 nm and a pH of 7.4 was obtained in the same manner as in Example 3 except that sodium dodecylbenzenesulfonate, which is an anionic emulsifier, was used in place of the betaine surfactant.

### Comparative Example 6

An aqueous dispersion (25) of resin fine particles, having an acid number of 10.0 mg KOH/g, an average particle size of 785 nm and a pH of 7.1 was obtained in the same manner as in Example 4 except that sodium dodecylbenzenesulfonate, which is an anionic emulsifier, was used in place of the betaine surfactant.

### Comparative Example 7

An aqueous dispersion (26) of resin fine particles, having an acid number of 10.0 mg KOH/g, an average particle size of 2560 nm and a pH of 6.6 was obtained in the same manner as in Example 5 except that sodium dodecylbenzenesulfonate, which is an anionic emulsifier, was used in place of the betaine surfactant.

### Comparative Example 8

The emulsification was performed in the same manner as in Example 6 except that sodium dodecylbenzenesulfonate, which is an anionic emulsifier, was used in place of the betaine surfactant; consequently, an aqueous dispersion (27) of resin fine particles, having an acid number of 10.0 mg KOH/g, an average particle size of 350 nm and a pH of 7.5 was obtained.

### Comparative Example 9

The emulsification was performed in the same manner as in Example 7 except that sodium dodecylbenzenesulfonate, which is an anionic emulsifier, was used in place of the betaine surfactant; consequently, an aqueous dispersion (28) of resin fine particles, having an acid number of 10.0 mg KOH/g, an average particle size of 210 nm and a pH of 7.5 was obtained.

### Comparative Example 10

The emulsification was performed in the same manner as in Example 12 except that sodium dodecylbenzenesulfonate, which is an anionic emulsifier, was used in place of the betaine surfactant; however, the resin fine particles were aggregated and no aqueous dispersion of resin fine particles was able to be produced.

### Comparative Example 11

The emulsification was performed in the same manner as in Example 13 except that sodium dodecylbenzenesulfonate, which is an anionic emulsifier, was used in place of the betaine surfactant; consequently, an aqueous dispersion (29) of resin fine particles, having an acid number of 25 mg KOH/g, an average particle size of 205 nm and a pH of 7.5 was obtained.

### Comparative Example 12

The emulsification was performed in the same manner as in Example 14 except that sodium dodecylbenzenesulfonate, which is an anionic emulsifier, was used in place of the betaine surfactant; consequently, an aqueous dispersion (30) of resin fine particles, having an acid number of 37 mg KOH/g, an average particle size of 153 nm and a pH of 7.5 was obtained.

### Comparative Example 13

The emulsification was performed in the same manner as in Example 15 except that sodium dodecylbenzenesulfonate, which is an anionic emulsifier, was used in place of the betaine surfactant; consequently, an aqueous dispersion (31) of resin fine particles, having an acid number of 18 mg KOH/g, an average particle size of 157 nm and a pH of 7.5 was obtained.

### Comparative Example 14

The emulsification was performed in the same manner as in Example 16 except that sodium dodecylbenzenesulfonate, which is an anionic emulsifier, was used in place of the betaine surfactant; consequently, an aqueous dispersion (32) of resin fine particles, having an acid number of 18 mg KOH/g, an average particle size of 475 nm and a pH of 7.5 was obtained.

### Comparative Example 15

The emulsification was performed in the same manner as in Example 17 except that sodium dodecylbenzenesulfonate, which is an anionic emulsifier, was used in place of the betaine surfactant; consequently, an aqueous dispersion (33) of resin fine particles, having an acid number of 9 mg KOH/g, an average particle size of 470 nm and a pH of 7.5 was obtained.

### Comparative Example 16

The emulsification was performed in the same manner as in Example 18 except that sodium dodecylbenzenesulfonate, which is an anionic emulsifier, was used in place of the betaine surfactant; however, the resin fine particles were aggregated and no aqueous dispersion of resin fine particles was able to be produced.

### Comparative Example 17

The emulsification was performed in the same manner as in Example 18 except that sodium dodecylbenzenesulfonate, which is an anionic emulsifier, was used in place of the betaine surfactant; consequently, an aqueous dispersion (34) of resin fine particles, having an acid number of 32 mg KOH/g, a particle size of 210 nm and a pH of 7.5 was obtained.

### Comparative Example 18

The emulsification was performed in the same manner as in Example 17 except that 1.7 parts of sodium dodecylbenzenesulfonate, which is an anionic emulsifier, was used in place of the betaine surfactant; consequently, an aqueous dispersion (35) of resin fine particles, having an acid number of 32 mg KOH/g, a particle size of 870 nm and a pH of 7.5 was obtained.

As described above, when emulsifiers other than the betaine surfactant were used in place of the betaine surfactant, the average particle size of the resin fine particles in the obtained aqueous dispersion of resin fine particles became larger than the average particle size of the resin fine particles in the aqueous dispersion of resin fine particles, prepared by using a betaine surfactant, and no aqueous dispersion of resin fine particles was able to be obtained as the case may be.

Next, Examples according to the toner of the present invention are presented.

<<Production of Aggregated Toner>>

(Preparation of Release Agent Dispersion)

| | |
|---|---|
| Paraffin wax | 100 parts |
| (HNP019, manufactured by Nippon Seiro Co., Ltd., | |
| melting point: 90° C.) | |
| Anionic Surfactant | 10 parts |
| (Neogen RK, manufactured by Dai-ichi Kogyo | |
| Seiyaku Co., Ltd.) | |
| Ion exchange water | 1000 parts |

After the aforementioned components were mixed and dissolved, the resulting mixture was dispersed by using a homogenizer (Ultra-Talax, manufactured by IKA Works, Inc.), and dispersion-treated with the high pressure impact-type disperser Ultimaizer (HJP30006, manufactured by Sugino Machine Ltd.) to prepare a release agent dispersion having an average particle size of 190 nm.

(Preparation of Pigment Dispersion)

After 3 parts of an anionic surfactant (Neogen RK, Dai-ichi Kogyo Seiyaku Co., Ltd.) was dissolved in 87 parts of ion exchange water, 10 parts of a cyan pigment (ECB-301, manufactured by Dainichiseika Color & Chemicals Mfg. Co.), Ltd.:-301) was added to the resulting solution and dispersion-treated with the high pressure impact-type disperser Ultimaizer (HJP30006, manufactured by Sugino Machine Ltd.) to prepare a pigment dispersion having an average particle size of 175 nm.

### Example 21

A mixture composed of 160 parts of the aqueous dispersion (15) of resin fine particles, 10 parts of the pigment dispersion, 10 parts of the release agent dispersion and 0.2 part of magnesium sulfate was dispersion-treated by using a homogenizer (Ultra-Talax T50, manufactured by IKA Works, Inc.), and then the resulting dispersion was heated to 65° C. in a heating oil bath while being stirred with a stirring blade. The dispersion was maintained at 65° C. for 1.0 hour, and then observed with the Coulter counter TA-II, to verify the formation of the aggregated particles having an average particle size of 6.0 μm. After 2.2 parts of an anionic emulsifier was added to the dispersion, the dispersion was heated to 80° C. under continuing stirring and then maintained at 80° C. for 30 minutes, and then the dispersion was observed with an optical microscope to result in observation of coalesced spherical particles having an average particle size of 5.5 μm. Subsequently, the dispersion was cooled to 30° C. at a rate of 10° C./min to solidify the particles. Then, after the reaction product was filtered, the reaction product on the filter was taken out; the cleaning step in which the reaction product was added in 720 parts of ion exchange water and stirred for 60 minutes, and then the reaction product was filtered was repeated 10 times; thus the electric conductivity of the filtrate was found to be 102 μS/cm, and hence the reaction product was evaluated to be sufficiently cleaned. It is to be noted that the filtrate was nearly transparent from the first cleaning.

Next, by using a vacuum dryer, the reaction product was dried to yield toner particles. The weight average particle size (D4) of the obtained toner particles was found to be 5.5 μm. It is to be noted that the electric conductivity of the filtrate was derived according to Japanese Patent Application Laid-Open No. 2006-243064. Specifically, the first 30 parts of the filtrate was discarded, the temperature of the rest of the filtrate was set at 25±0.5° C., then the electric conductivity was measured with an electric conductivity meter (trade name: “ES-12,” manufactured by Horiba, Ltd.), and the electric conductivity of the sample was derived on the basis of the following formula.

Electric conductivity μS/cm=A−B

A: Electric conductivity of filtrate
B: Electric conductivity of water used for cleaning

The electric conductivity and the pH of the ion exchange water used were 5 μS/cm or less and 7.0±1.0.

With 100 parts of the toner particles, 1.8 parts of hydrophobized silica fine powder having a specific surface area of 200 m²/g as measured with the BET method was dry mixed with a Henschel mixer (manufactured by Mitsui Mining Co., Ltd.) to prepare a toner. By using a commercially available color laser printer (LBP-5500, manufactured by Canon, Inc.) modified so as to have a nearly doubled process speed, with the aforementioned individual toners packed in the magenta cartridges, image printing out was performed on plain paper (color laser copier paper, manufactured by Canon, Inc.), at normal temperature and normal humidity, and satisfactory image free from problems was obtained.

### Comparative Example 20

Toner particles were prepared in the same manner as in Example 21 except that the aqueous dispersion (34) of resin fine particles was used in place of the aqueous dispersion (15) of resin fine particles; the filtrate in each of the first to third filtration steps was a milky solution due to the detachment of the release agent, and the filtrate was transparent in the fourth or later cleaning. The release agent in the milky solution was collected, and it was revealed that 2.3 parts of 10 parts of the release agent used for the toner particle production was calculated to flow out, and hence no intended toner was able to be produced from the viewpoint of the constitution.

### Comparative Example 21

Toner particles were prepared in the same manner as in Example 21 except that the aqueous dispersion (35) of resin fine particles was used in place of the aqueous dispersion (15) of resin fine particles; the filtrate in each of the first to third filtration steps was a milky solution due to the detachment of the release agent dispersion, and the filtrate was transparent in the fourth or later cleaning. The release agent in the milky solution was collected, and it was revealed that 3.5 parts of 10 parts of the release agent used for the toner particle production was calculated to flow out, and hence no intended toner was able to be produced from the viewpoint of the constitution.

<<Production of Core-Shell Toner Particles>>

### Example 22

A mixture composed of 160 parts of the aqueous dispersion (15) of resin fine particles, 10 parts of the pigment dispersion, 10 parts of the release agent dispersion and 0.2 part of magnesium sulfate was dispersion-treated by using a homogenizer (Ultra-Talax T50, manufactured by IKA Works, Inc.), and then the resulting dispersion was heated to 65° C. in a heating oil bath while being stirred with a stirring blade. The dispersion was maintained at 65° C. for 1.0 hour, and then observed with an optical microscope to verify the formation of the aggregated particles having an average particle size of 5.5 μm. Next, to the dispersion, 10 parts of the aqueous dispersion (1) of resin fine particles to be used for forming the shell phase was added, then 0.1 part of magnesium sulfate was added, and the resulting dispersion was continuously stirred under the condition of 65° C. for 1 hour with a stirring blade, and then the dispersion was heated to 80° C. and maintained at 80° C. for 30 minutes. After maintaining at 80° C., the dispersion was observed with an optical microscope to result in observation of coalesced spherical particles having an average particle size of 6.0 μm. Subsequently, the dispersion was cooled to 30° C. at a rate of 10° C./min to solidify the particles. Then, after the reaction product was filtered, the reaction product on the filter was taken out; the cleaning step in which the reaction product was added in 720 parts of ion exchange water and stirred for 60 minutes, and then the reaction product was filtered was repeated 10 times; thus the electric conductivity of the filtrate was found to be 105 μS/cm, and hence the reaction product was evaluated to be sufficiently cleaned. It is to be noted that the filtrate was nearly transparent from the first cleaning.

Next, by using a vacuum dryer, the reaction product was dried to yield core-shell toner particles. The weight average particle size (D4) of the obtained toner particles was found to be 6.0 μm. The toner particles were observed with a reflection electron microscope, and the coating of the core particles with the shell particles was found to be sufficiently performed. The obtained toner particles were stored for 1 week in an environment of a temperature of 40° C. and a relative humidity of 80%, and no visual difference was found between before and after the storage.

### Comparative Example 22

Core-shell toner particles were produced with the method used in Example 22 except that the aqueous dispersion (34) of resin fine particles was used in place of the aqueous dispersion (1) of resin fine particles used to form the shell phase. The core-shell toner particles were observed with a reflection electron microscope, and the coating of the core particles with the resin particles for the shell was found to be insufficient. The obtained toner particles were stored for 1 week in an environment of a temperature of 40° C. and a relative humidity of 80%, and thus, the toner particles turned into a solid mass and the toner shape was not able to be maintained in this environment.

### Comparative Example 23

Core-shell toner particles were produced with the method used in Example 22 except that the aqueous dispersion (35) of resin fine particles was used in place of the aqueous dispersion (1) of resin fine particles used to form the shell phase. The core-shell toner particles were observed with a reflection electron microscope, and the coating of the core particles with the resin particles used for forming the shell phase was found to be insufficient. The obtained core-shell toner particles were stored for 1 week in an environment of a temperature of 40° C. and a relative humidity of 80%, and thus, the toner particles turned into a solid mass and the toner shape was not able to be maintained in this environment.

The aqueous dispersion of resin fine particles of the present invention and the method for producing the aqueous dispersion of resin fine particles can be suitably used for the production of the toners used in electrophotography, electrostatic recording, electrostatic printing and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-022764, filed Feb. 6, 2012 which is hereby incorporated by reference herein in its entirety.

What is claimed is:

1. A method for producing an aqueous dispersion of resin fine particles, comprising the steps of:
(A-1) preparing a mixture A by mixing a resin having an acid group, a betaine surfactant and a solvent capable of dissolving the resin; and
(A-2) preparing an emulsion A by adding the mixture A into an aqueous medium, and applying shear force to the mixture A in the aqueous medium under a condition of pH=7.0 or more.

2. The method for producing an aqueous dispersion of resin fine particles according to claim 1, wherein the betaine surfactant comprises a carboxylate group.

3. The method for producing an aqueous dispersion of resin fine particles according to claim 1, wherein the betaine surfactant is an amide betaine.

4. A method for producing an aqueous dispersion of resin fine particles, comprising:
(B-1) preparing a mixture B by mixing a resin having an acid group, a betaine surfactant and an aqueous medium; and
(B-2) preparing an emulsion B by applying shear force to the resin in the mixture B under a condition of pH=7.0 or more and at a temperature equal to or higher than the glass transition temperature (Tg) of the resin.

5. The method for producing an aqueous dispersion of resin fine particles according to claim 4, wherein the betaine surfactant comprises a carboxylate group.

6. The method for producing an aqueous dispersion of resin fine particles according to claim 4, wherein the betaine surfactant is an amide betaine.

7. A method for producing a toner comprising toner particles each of which includes a binder resin and a colorant, wherein the toner particles are obtained by:
aggregating the resin fine particles and the colorant in the aqueous medium, after the aqueous dispersion of resin fine particles produced by the method according to claim 1 and a colorant are mixed, to obtain an aqueous dispersion of aggregates; and
fusing the aggregates by heating the aqueous dispersion of the aggregates.

8. A method for producing a toner comprising toner particles each of which includes a binder resin and a colorant, wherein the toner particles are obtained by:
aggregating the resin fine particles and the colorant in the aqueous medium, after the aqueous dispersion of resin fine particles produced by the method according to claim 4 and a colorant are mixed, to obtain an aqueous dispersion of aggregates; and
fusing the aggregates by heating the aqueous dispersion of the aggregates.

9. A method for producing a toner comprising toner particles each of which includes
a core particle containing a binder resin and a colorant and
a shell phase formed on the surface of the core particle,
wherein the toner particles are obtained by:
forming the shell phase by attaching the resin fine particles in the aqueous dispersion of resin fine particles produced by the method according to claim 1 to the core particle.

10. A method for producing a toner comprising toner particles each of which includes
a core particle containing a binder resin and a colorant and
a shell phase formed on the surface of the core particle,
wherein the toner particles are obtained by:
forming the shell phase by attaching the resin fine particles in the aqueous dispersion of resin fine particles produced by the method according to claim 4 to the core particle.
